(19) United States
(12) Patent Application Publication
(10) Pub. No.: US 2009/0248517 A1
(43) Pub. Date: Oct. 1, 2009

(54) Systems and methods for distributed commerce platform technology

(75) Inventors: Sieng van Tran, London (GB); Charles Denton, (US); Roger Chick, Kent (GB); Phuong Van Tran, London (GB); Minh Tam Tran, (US); Hong Thi Tran, London (GB); Eric Metens, San Francisco, CA (US)

Correspondence Address: BRYAN CAVE LLP, 211 NORTH BROADWAY, SUITE 3600, ST. LOUIS, MO, 63102-2750, US

(73) Assignee: Price Dive Ltd.

(21) Appl. No.: 12/079,526

(22) Filed: Mar. 27, 2008

(51) Int. Cl. G06Q 30/00

(52) U.S. Cl. 705/14; 705/26

(57) ABSTRACT

The present invention provides methods and systems to facilitate distributed commerce. A distributed commerce system comprises a module for communicating an advertisement, price information, or viewer information and using the information to calculate a price based on the number of viewers. In another embodiment, a system is provided for valuating the viewers and determining a price based upon the viewers' value.

### FIELD OF INVENTION

The present invention relates to systems and methods for distributed commerce platform technology, and more specifically to associate real time status and prices for goods with the number of website visits.

### BACKGROUND OF THE INVENTION

Current e-commerce systems offer two types of pricing structures: static and dynamic pricing. In the static pricing schemes, a retailer sets the sale price of a product and a consumer purchases the product at the sale price. In the dynamic pricing scheme, a retailer may choose to set a reserve sale price or no sale price at all, and consumers bid against one another to purchase the product. The consumer with the highest bid at the end of the time period for the sale will be able to purchase the product. In both situations, the retailer and the consumer take on the costs associated with the sale. What is needed, therefore, is a system for e-commerce in which the costs to the seller and buyer are reduced or eliminated. The present invention provides these and other advantageous results.

### SUMMARY OF THE INVENTION

The present system provides methods and systems to facilitate distributed commerce. In one exemplary embodiment, a distributed commerce system comprises a commerce site that provides a first sale price and an advertisement, a central processor configured for calculating a rate of advertising subsidy, and a module with a counter for counting the number of visitors to the commerce site. The central processor can use the information regarding the number of visitors to the commerce site and the rate of advertising subsidy to calculate a second sale price.

In another exemplary embodiment, a dynamic pricing tag is configured to display a first price of a product. A first viewer module and a second viewer module are configured for interaction between a first viewer and the pricing tag and a second viewer and the pricing tag. A central processor in communication with the pricing tag and the first and second viewer modules calculates a rate of subsidy based on information about the viewers and the central processor further calculates a second sale price to the pricing tag based on the rate of subsidy

### BRIEF DESCRIPTION OF THE DRAWINGS

The invention will be better understood from a reading of the following detailed description, taken in conjunction with the accompanying Figures in the drawings in which:

FIG. 1 illustrates a block diagram of an exemplary distributed commerce platform in accordance with the invention;

FIG. 2 illustrates an exemplary Contextual Advertisement (CA) in accordance with the present invention;

FIG. 3 illustrates a block diagram of an exemplary Dive Velocity chart in accordance with the invention;

FIG. 4 illustrates a block diagram of an exemplary method for providing a catch price dive in accordance with the invention;

FIG. 5 illustrates a block diagram of an exemplary stand-alone device (SAD) in accordance with the invention;

FIG. 6 illustrates a block diagram of an exemplary advertisement scheme in accordance with the invention;

FIG. 7 illustrates a block diagram of an exemplary Dive Velocity chart where the viewer weight influences the Dive Velocity in accordance with the invention; and

FIG. 8 illustrates an exemplary chart of tiered data in accordance with the present invention.

### DETAILED DESCRIPTION OF THE INVENTION

The detailed description of exemplary embodiments of the invention herein makes reference to the accompanying drawings, which show the exemplary embodiment by way of illustration and its best mode. While these exemplary embodiments are described in sufficient detail to enable those skilled in the art to practice the invention, it should be understood that other embodiments can be realized and that logical and mechanical changes can be made without departing from the spirit and scope of the invention. Thus, the detailed description herein is presented for purposes of illustration only and not of limitation. For example, the steps recited in any of the method descriptions can be executed in any order and are not limited to the order presented.

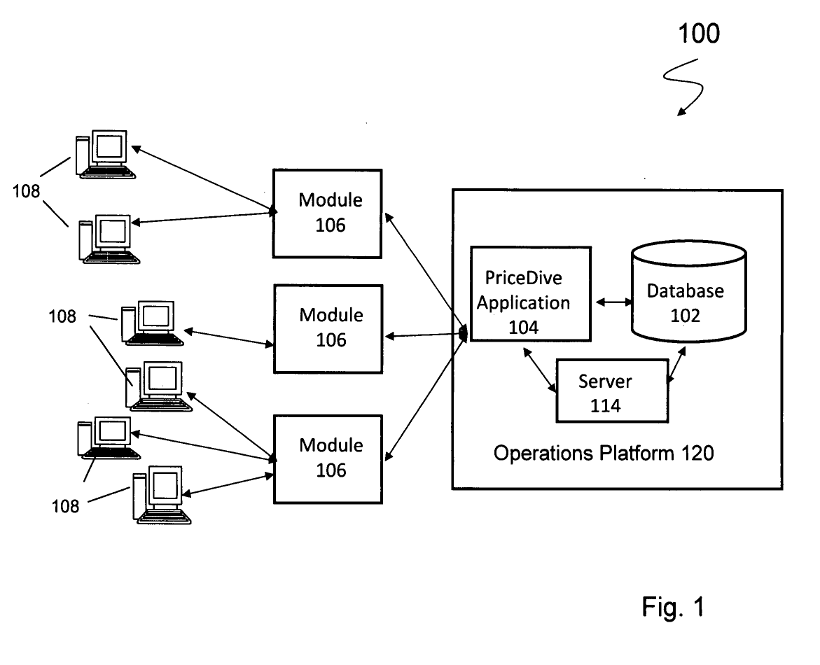

The systems and methods described above can be further illustrated with respect to a block diagram of an exemplary distributed commerce platform (DCP) 100, depicted in exemplary FIG. 1. DCP 100 is a distributed platform of systems and hardware configured to facilitate distributed commerce. DCP 100 comprises one or more operational platforms (OP) 120 for facilitating back-end processing. OP 120, in turn comprise one or more price dive applications (PDAs) 104, servers 114, databases 102 and/or the like for storing, receiving, processing and/or communicating distributed commerce information.

Distributed commerce information, as used herein, includes any type of advertising information, auction information, sales information, buyer information, seller information, viewer information, and/or the like. PDA 104 comprises software and/or hardware elements to facilitate processing information from databases 102 and/or server 114. PDA 104 is also configured to facilitate communicating database 102 and/or server 114 information to one or more distributed commerce platform (DCP) modules 106.

Database 102 comprises one or more devices and/or software systems for storing data in analog or digital format. Database 102 includes, but is not limited to, magnetic tape, flash drives, RAM, hard drives, databases, optical storage devices, zip drives, and the like. The databases used herein can comprise one or more local, remote or other databases used for information storage and retrieval. The databases can be a graphical, hierarchical, relational, index sequential database (for example, primarily an OS supplied file system), object-oriented database and/or any other type of database known in the art.

Server 114 can comprise one or more servers and any hardware and/or software suitably configured to facilitate communications between the various system components as discussed herein. Server 114 can operate as a single entity in a single geographic location or as separate computing components located together or in separate geographic locations. Information received and/or processed at server 114 may pass through a firewall prior to being received and processed. Additionally, as used herein, “data” may include encompassing information such as commands, queries, files, data for storage, and the like in digital or any other form. Server 114 may provide a suitable web site or other Internet-based graphical user interface elements which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, ORACLE, SYBASE, INFORMIX MySQL, InterBase, etc., may be used to provide an Active Data Object (ADO) compliant database management system.

OP 120 comprises any type of software and/or hardware to facilitate communication and data storage within DCP 100. For example, OP 120 can comprise one and/or more of the following: a host server and/or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. As those skilled in the art will appreciate, OP 120 can include an operating system (e.g., MVS, Windows NT, 95/98/2000/XP, OS2, UNIX, MVS, TPF, Linux, Solaris, MacOS, AIX, etc.) as well as various conventional support software and drivers typically associated with computers.

Modules 106 are configured as software elements and/or hardware elements to perform a multitude of DCP 100 tasks and/or front-end processing. For example, in one exemplary embodiment modules 106 are configured to present Dives to one or more users 108. A Dive, as used herein, is a sale for a product, service, good and/or the like, wherein the price decreases over time depending on one or more viewing factors. A Dive can be presented in real-time, delayed, over the Internet, and/or in a traditional brick and mortar environment. Viewing factors, as described herein, include, but are not limited to the rate of viewers viewing a Dive, the cost to advertisers for advertising during a Dive, the number of unique visitors to a Dive, the length of time of the Dive, the reserve price of a Dive, a current bid on a Dive, an accumulation of bids on a Dive, the cost of a product for sale in a Dive and/or the like. For example, in one embodiment, module 106 uses software to detect the number of unique IP addresses on a website at any one instant in time, for example, at any one minute.

DCP 100 can be further explained with reference to an exemplary Contextual Advertisement (CA) 200 in accordance with the present invention. CA 200 uses one or more modules 106 to display an advertisement 204 on a website 210 and/or other form of media. Module 106 uses one or more algorithms to scan and process content, text, meta data and/or other data (“meta data”) associated with website 210.

Module 106 extracts this meta data information and sends it to OP 120. PDA 104 in turn accesses information from database 102 and/or server 114 that is related to the extracted meta data information. OP 120 then communicates the database 102 information to module 106, which pushes advertisement 204 onto website 210 that is related to website 210 meta data. For example, in one exemplary embodiment, module 106 uses Natural Language Processing (NLP) algorithms to analyze the text on the page, extracting key entities from the wording, and weighting page META tags and titles to provide the meta data from website 210 to OP 120.

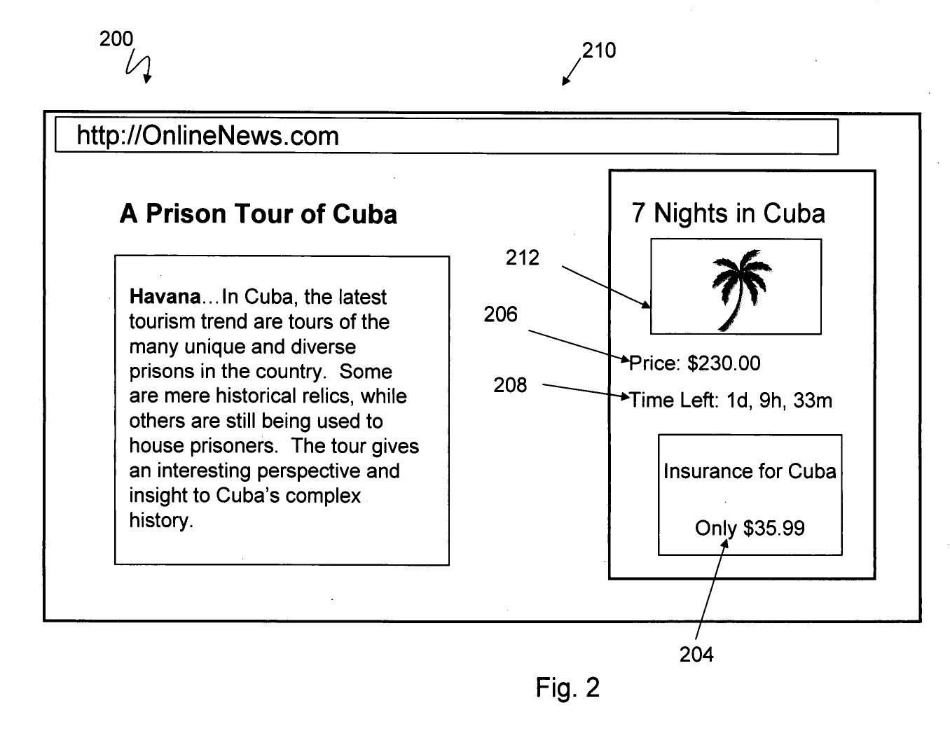

With reference to FIG. 2, module 106 scans the meta data related to Cuba of website 210, extracts and sends this information to OP 120, such that PDA 104 can access advertisement 204 information from database 102 and/or server 114 related to Cuba. This advertisement 204 information is then pushed onto website 210 by module 106.

Advertisement 204 information may be in the form of computer code and/or any other form of data. Module 106 can be configured with one or more algorithms to transform database 102 information, such as advertisement 204 information, into a web-viewable format, for example, as depicted in FIG. 2. Module 106 can further be configured to dynamically modify content within advertisement 204.

Similarly, module 106 can be configured to push Dive 212 information onto website 210. That is, module 106 can communicate meta data information related to a website and/or other form of media to OP 120. OP 120 can then use this meta data information to access and communicate one or more related Dives to module 106. Module 106 can in turn communicate the Dive 212 information to website 210. For example, with reference to FIG. 2, module 106 and OP 120 can use meta data information related to Cuba to communicate Dive 212, relating to a trip to Cuba, to website 210.

As used herein, the terms “communicate”, “transmit” and/or “pushed” are use herein to mean any form of transmittal, pushing, pulling, streaming, casting, communicating and/or the sending of electronic data from one system component to another over a network connection. Module 106 can be configured to use JavaScript and/or any similar type of code to communicate information to website 210. Communication can be achieved over one or more networks. As used herein, a “network” comprises any electronic communications means which incorporates both hardware and software components of such. The network can comprise any suitable communication channels, such as, for example, a telephone network (such as a public switched telephone network or Integrated Services Digital Network (ISDN)), an extranet, an intranet, Internet, point-of-interaction device (personal digital assistant, cellular phone, kiosk, etc.), online communications, off-line communications, wireless communications, transponder communications, radio frequency communications, Bluetooth communications, a local area network (LAN), wide area network (WAN), networked and/or linked devices and/or the like. Moreover, the network may also implement TCP/IP communications protocols, IPX, Appletalk, IP-6, NetBIOS, OSI and/or any number of existing and/or future protocols. If communications are made over a network that is in the nature of a public network, such as the Internet, various encryption and security protocols may be used to secure the network. Specific information related to the protocols, standards, and application software utilized in connection with the Internet is generally known to those skilled in the art and, as such, need not be detailed herein.

Prior to and/or at the same time that module 106 communicates information to website 210 DCP 100 initiates an agreement with the owner of website 210. That is, DCP 100 can affiliate with one or more websites, retail stores and/or other forms of commerce (“commerce site”) to establish an agreement by which DCP 100 is permitted to communicate information to/from the commerce site. Once module 106 is added to the affiliate commerce site, module 106 can immediately cull and/or communicate information to/from OP 120.

As used herein, an “affiliated” commerce site is a site of a third party that has a pre-established affiliation with DCP 100. Affiliates may be compensated by a portion of the fees earned in a Dive for allowing the placement of Dive and/or advertising information on their site. OP 120 can be configured to receive and store affiliate information such as invoicing information, operability information, and/or the like, such that each sale made through an affiliate commerce site may be stored and tallied within a database 102 within OP 120. OP 120 can further be configured to facilitate payment to affiliates at some predetermined interval (for example, when affiliate revenues reach $100 or on the first of every month). Accordingly, OP 120 can use affiliate revenue and invoicing information to transfer payments to affiliate on a regular basis.

Module 106 can also be configured to communicate new price information 206 and/or time information 208 into Dive 212. In one exemplary embodiment, module 106 is configured to use a standard Struts 2 framework utilizing AJAX and Java to facilitate refreshing and displaying Dive 212 content on website 210. As such, module 106 provides visitor 108 updated information without visitor 108 having to manually refresh and/or reload the entire website 210. Moreover, module 106 enables visitor 108 to interact with Dive 212 without leaving website 210.

For example, in one embodiment, module 106 is configured to update Dive 212 with new time 208 and price 206 information every second. However, the timing of module 106 communications can be set at any interval and/or can be configured to be continuous. In one exemplary embodiment, visitors 108 to website 210 can see a real time status for all advertised Dives 212 and be presented with relevant advertisements 204 to the website content. In another exemplary embodiment in accordance with the present invention, module 106 can be configured to communicate a new Dive and/or advertisement to website 210 once Dive 212 comes to an end.

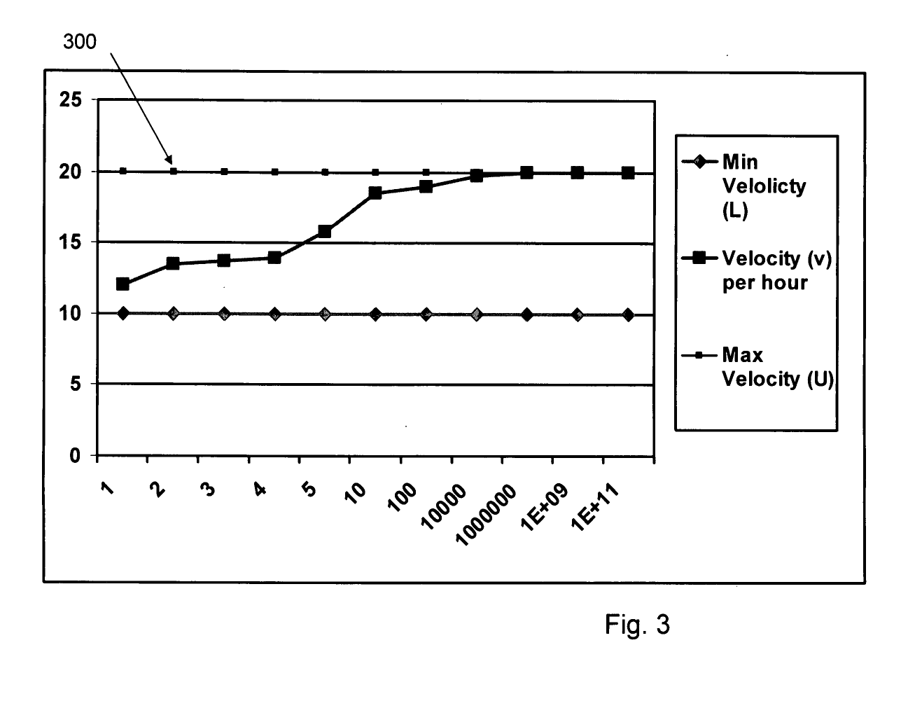

With reference to an exemplary chart illustrated in FIG. 3 in accordance with the present invention, module 106 and/or PDA 104 can be configured to calculate the Dive Velocity 300 for a particular Dive. The Dive Velocity, as used herein, refers to the speed at which a particular Dive reduces in price over a particular amount of time. In one exemplary embodiment, the Dive Velocity is dynamically set according to how many users are currently watching a particular Dive. That is, as the number of viewers of a Dive increase, the faster the price of the Dive reduces. As such, time 208 may not be displayed for such a viewer-based Dive 212, as the timing of Dive 212 varies depending upon the number of viewers.

For example, in one exemplary embodiment, module 106 is configured to measure the amount of time each viewer 108 spends on a website and/or to detect each new IP address that links to a particular website. Module 106 then communicates this time and/or viewer information to OP 120, which updates server 114. PDA 104 uses server 114 information to determine the Dive Velocity and to measure an advertised audience size. If there are zero viewers 108 viewing a site, then the Dive Velocity will equal some predetermined minimum velocity.

In one exemplary embodiment, PDA 104 calculates the Dive Velocity between an upper limit velocity, u, and a lower limit velocity, l. Upper limit u and lower limit l can be any limit determined by DCP 100 and l and u are subject to the initial price of the listing. For example, a trip to Cuba may have an upper limit velocity of 10% of the product price and a lower limit velocity of 5% of the product price. However, the upper and lower limits can be set to any percentages of the product price. For example, in one embodiment, the actual product price of a product is $4000 and the percentages used to establish the upper and lower limits are 15% and 5%, respectively. In another exemplary embodiment, the lower limit may be set close to or at zero, or 0% of the product price. PDA 104 uses the information about the number of users, r, viewing advertisement 214. This number can be any number between one and infinity. For example, r can be 100. Accordingly, velocity, v, per hour can be calculated as:

$$v = l + ( ( \frac{arctan ( r / 10 )}{π / 2} ) \times ( u - l ) )$$

Using the example numbers, the Dive Velocity would therefore be calculated as $574.62 dollars/hour. This means that because of the large number of viewers, the trip to Cuba will drop in price rapidly and the price of the Dive will reach zero within seven hours. PDA 104 can also be configured to continuously adjust the Dive Velocity throughout the Dive. For example, if initially there are only 2 viewers, the Dive Velocity would be $250.27 dollars/hour, and therefore the Dive would reach zero within sixteen hours. Module 106 can communicate viewer number information to PDA 104 at some predetermined interval, and PDA 104 can calculate a new Dive Velocity of the Dive. Accordingly, at some unknown time period to the viewers 108, the velocity of the Dive can increase dramatically, depending on the number of visitors to the website. However, once the number of viewers 108 reaches a certain threshold, the velocity of the Dive will level off and not fluctuate very much. See, for example, the tailing off of the Dive Velocity illustrated in FIG. 3.

A Dive, as described herein, can be configured to have a “catch price”, a “reserve price” and/or “no reserve.” A “catch price” can be established by a user watching a Dive. The user can be pre-registered and/or a new user. The user can watch a Dive and predetermined an amount at which the user will agree to purchase a product or service. For example, if a Dive is for a trip to Cuba, the user can determine that once the Dive price reaches $2500, the user will purchase the product. The user can determine his catch price at any time prior to or during a Dive. In one exemplary embodiment, upcoming Dives are advertised on a central website so that users can pre-select their catch prices for the Dives. A “reserve price” is the minimum price that the seller will take for his good offered in a Dive. For example, the seller of the trip to Cuba may set his reserve price at $2000. Accordingly, the Dive will be configured to end once the price of the trip falls to $2000. Similarly, in a “no reserve” Dive, there is no minimum price that a seller will take, and therefore, the Dive will continue until the trip to Cuba is purchased or the Dive times out.

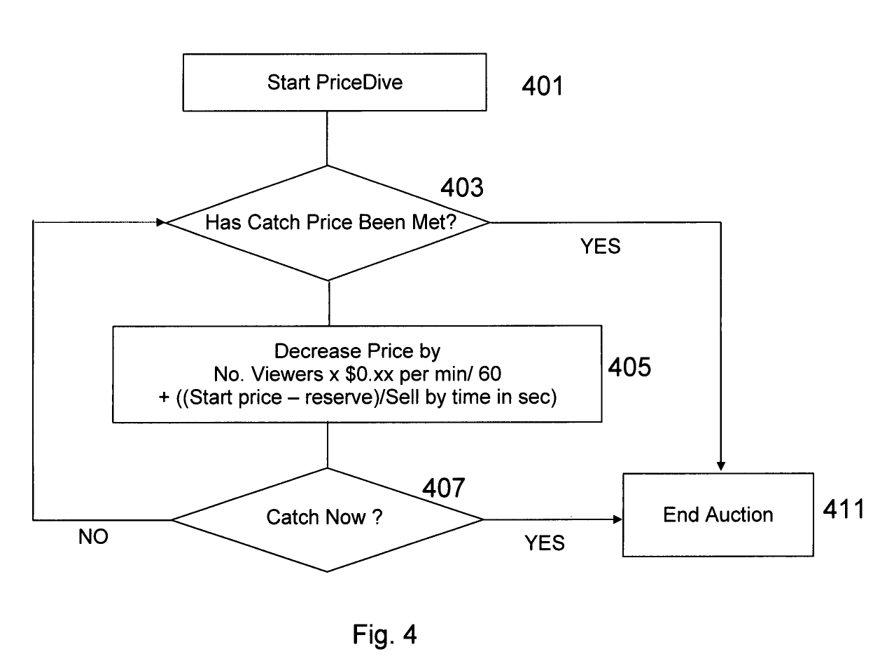

A method for providing a catch price dive in accordance with the present invention is described with reference to an exemplary block diagram illustrated in FIG. 4. Catch price dive 400 begins once module 106 uploads a Dive to a website (step 401). In addition, and/or in the alternative, viewers 108 can access a central website that displays one or more Dives. That is, viewers 108 can go to a Dive website and search the site for Dives related to specific products or services that they are interested in purchasing. Module 106 can be configured to operate a Dive simultaneously on a central website and one or more affiliated websites.

With reference again to FIG. 4, a Dive begins and PDA 104 calculates the current price of the product or service for sale in the Dive, using one of the methods described herein. PDA 104 further determines whether a user catch price has been met (step 403). If the catch price is met, the auction ends (step 411). If the catch price has not been met, PDA 104 is configured to use a predetermined algorithm to decrease the price of the product (step 405). For example, in one exemplary embodiment, PDA 104 is configured to decrease the price using the following algorithm: Number of viewers×$.xx per min/60+((start price−reserve)/sell by time in sec). PDA 104 receives information about the number of viewers from module 106. The seller can establish one or more of the start price, reserve price and sell-by time. If the catch price is met (step 407), the auction ends (step 411). If the catch price is not met, then step 405 repeats and the price is reduced again. This process continues until a user's catch price is finally met.

As used herein, the terms “viewer”, “visitor”, “buyer”, “user”, “bidder” and “consumer” may be used interchangeably to refer to a person or entity viewing and/or bidding on a product, service, merchandise and/or the like for sale in a Dive. The visitor can register by providing visitor information, such as for example, name address, billing information, a login, password, buying preferences and/or the like to a central website. This information is communicated to OP 120 and database 102.

A seller can list a product or service for sale on a Dive by accessing a central website for dive information and registering information through the website. The central website can provide information about the prices charged, if any, by DCP 100 for running a Dive. The seller can provide information about each product or service he is selling, including starting price, reserve price, payment information and/or the like. The seller can also set a desired Dive Velocity and provide billing information. Seller information is communicated to OP 120 and stored in database 102.

In one exemplary embodiment, the seller can agree to receive subsidies from PDA 104 based on one or more advertisers. For example, a seller listing a trip to Cuba may set his reserve price at $4000. However, the seller may also agree to receive PDA 104 subsidies from one or more advertisers in exchange for allowing the Dive for the Cuba trip to be tied to an advertisement. In this arrangement, the seller will accept less than $4000 for the trip, however the advertiser will pay the difference between the sale price (e.g., $2000) and the reserve price ($4000).

The subsidized price may be dependent upon the number of viewers of the Dive. For example, an insurance company selling travel insurance may subsidize the cost of the trip to Cuba based upon the number of viewers of a Dive for the trip. While the seller may have his reserve price set at $4000, the advertiser may agree to pay $2 per viewer of the Dive up to a certain advertising reserve price. The advertising reserve price can be any amount. For example, in one embodiment, the advertising reserve price is $1000. As module 106 detects each new viewer, this information is communicated to OP 120. The Dive can be configured such that once the reserve price ($4000) minus the advertising reserve price ($1000) is met, the Dive will end. In another embodiment, the advertiser can set a reserve price at $0, such that the Dive will not have any minimum.

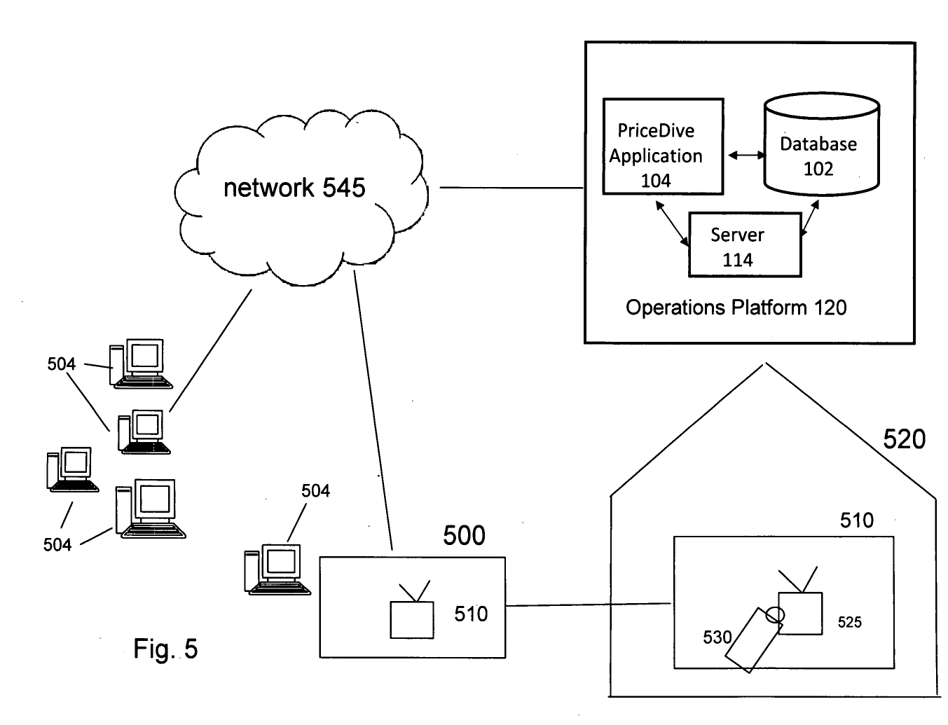

In another exemplary embodiment in accordance with the present invention, and with reference to an exemplary block diagram illustrated in FIG. 5, module 106 is configured as a stand-alone device (SAD) 500 to facilitate consumer interaction with the sale of a product or service (e.g., a Dive). SAD 500 can comprise one or more hardware devices and/or software protocols to facilitate communicating dive information. For example, SAD 500 can be configured as a computer and can comprise one and/or more of the following: a host server and/or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases.

SAD 500 can communicate with OP 120 and/or server 114, PDA 104 and/or database 102 through a direct connection and/or network connection 545. For example, in one exemplary embodiment SAD 500 is configured to communicate with OP 120 through a wireless network connection 545.

A user 504 can access information about a Dive 510 displayed on SAD 500 by using a display associated with SAD 500. For example, user 504 can look up an online dive 510 using a display on SAD 500. In another embodiment, SAD 500 can be configured to communicate price information to a dynamic tag association with a sale item. For example, a traditional retailer 520 may have a television 525 for sale that has a tag 530, which displays pricing information. The sale of television 525 may be linked and/or otherwise related to online dive 510. Tag 530 can detect one or more SAD 500 in communication with the tag and update price information of television 525 based upon the number of SADS 500 detected. For example, if three users 504 are watching television dive 510 on the Internet and four more users 504 are using SADs 500 to watch television dive 510 in the store, than the price of the television that is listed on tag 530 will reduce based on the fact that seven different users are watching dive 510.

Tag 530 can be configured with a transponder, with a wireless device, Bluetooth device and/or the like to communicate with SAD 500. For example, upon entering a store, user 504 can use SAD 500 to communicate with tag 530 to view a current price and/or to register for a dive related to television 525. That is, SAD 500 can be used to communicate tag 530 and user 504 information to OP 120 and database 102 through network 545.

In another exemplary embodiment, SAD 500 can be used to verify a user to minimize click fraud and/or secure a transaction. For example, SAD 500 can be configured with one or more identification protocols to verify the identity of user 504 of SAD 500. Identification protocols, as used herein, include, but are not limited to a Personal Identification Number (PIN), a password, an identifier, a biometric identifier (e.g., a fingerprint) and/or the like.

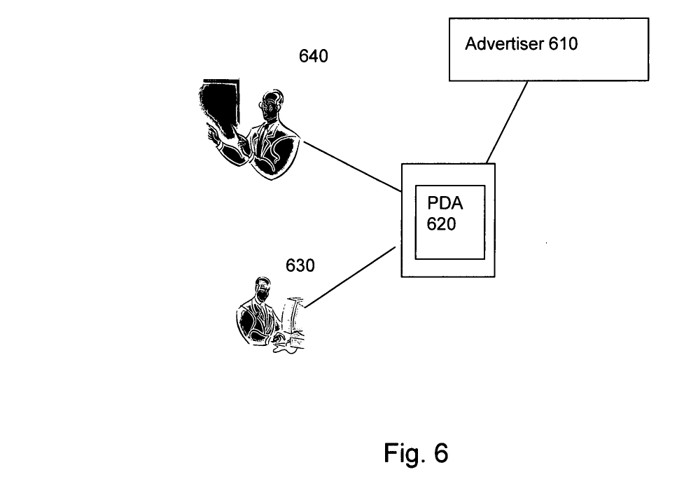

In another exemplary embodiment in accordance with the present invention, a Dive price can be related to the quality of viewers. For example, with reference to an exemplary block diagram illustrated in FIG. 6, an advertiser 610 negotiates a rate with PriceDive Application (PDA) 620, wherein advertiser will pay a larger fee for a prime viewer 630 than for a sub-viewer 640. PDA 620 is configured to collect data on prime and sub-viewers 630, 640 in order to qualify the viewers. For example, in one embodiment, PDA 620 issues a survey to viewers 630, 640 in order to gather information about viewers' 630, 640 spending habits, income level, social networks, Internet influences, marketing profile and/or the like. In another embodiment, PDA 620 can use one or more data mining algorithms to collect data related to viewers 630, 640. For example, PDA 620 can obtain information about the Internet cookies, time spent online, number of online sales, social network interaction and/or other Internet habits of viewers 630, 640.

PDA 620 can then weight and/or qualify viewers 630, 640 based upon the collected data. For example, frequent shoppers, frequent viewers, viewers with multiple and/or large social networks, viewers with more active social networks, viewers having informative market profiles, higher income viewers, viewers who subscribe to a website associated with PDA 620 and/or the like may be weighted and/or qualified as prime viewers, while infrequent viewers, infrequent shoppers, viewers with few and/or small social networks, viewers with inactive social network, viewers without market profiles, lower income viewers and/or the like may be weighted and/or qualified as sub-users. In one embodiment in accordance with the present invention, the Dive Velocity for a Dive may depend upon the number of viewers and/or the quality of the viewers. For example, a prime viewer may count as two or more viewers, while a sub-viewer my count only as a minimum of a single a viewer. In another embodiment, PDA 620 is configured to assign a weight to each type of viewers 630, 640, and the average weight value is used by PDA 620 to determine a Dive Velocity for a Dive.

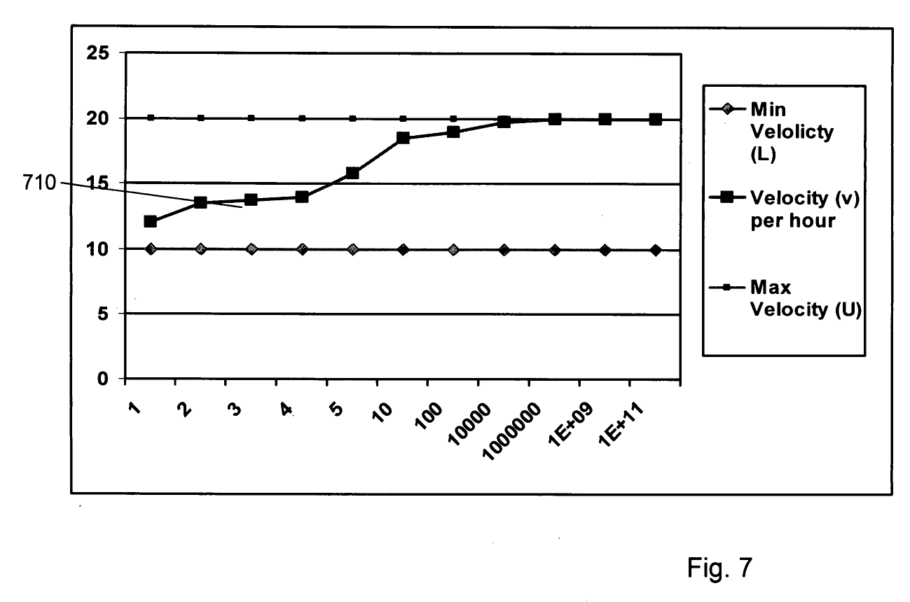

An exemplary chart 700 depicted in FIG. 7 further illustrates how the viewer weight influences the Dive Velocity. For example, a Dive Velocity 710 is calculated between two limits set by PDA 620, a lower limit, l, and an upper limit, u, wherein l and u are subject to the initial price of the listing. The number of users, r, viewing the listing can range anywhere between 1 and infinity, and each user is assigned a worth or weight, w, based on the user's market profile. The weight can range from 1 to the value of upper limit, u. Accordingly, Dive Velocity 710, v, will be calculated as:

$$v = l + ( \frac{arctan ( ( r + {\sum }_{1}^{r} w ) / r \times 10 )}{π / 2} ) \times ( u - l ) )$$

In yet another embodiment, PDA 620 can subsidize the Dive price based upon which viewer 630, 640 is viewing the Dive. For example, if prime viewer 640 is viewing a Dive for a trip to Cuba, prime viewer 640 may see a Dive price of $2500, where PDA 620 subsidizes $50 of the actual $2550 trip price. Sub-viewer 630, however, will view the trip price as $2550 because he does not receive the benefit of the subsidized price. This subsidized price can be based upon an agreement with advertiser 610, wherein advertiser 610 agrees to pay a first price for each prime viewer 640 and a second price for each sub viewer 630. As such, PDA 620 can offer a lower price of a Dive for prime viewer 640 than for sub viewer 630.

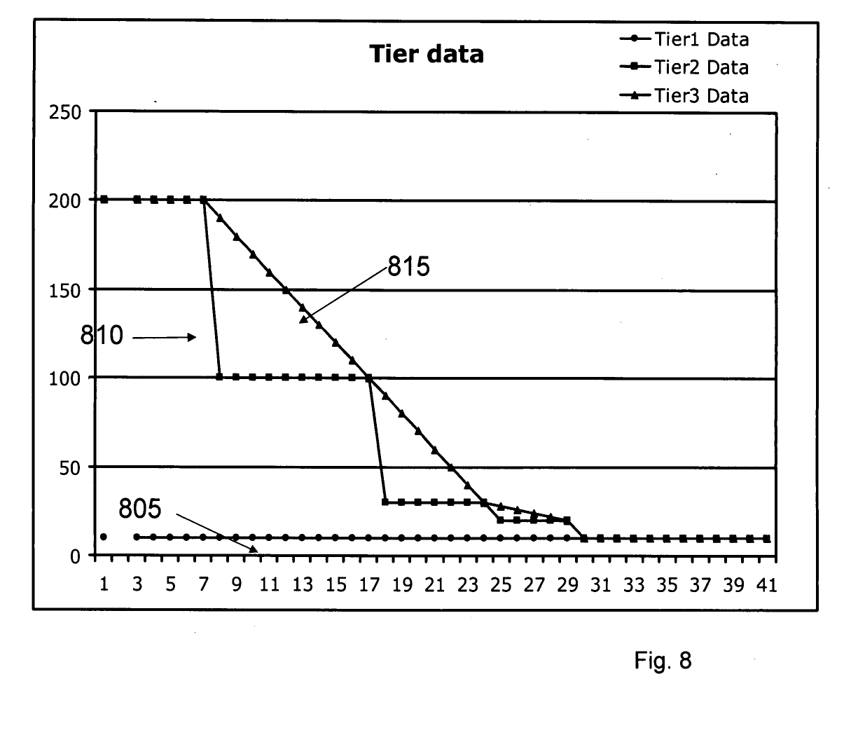

In yet another exemplary embodiment in accordance with the present invention and with reference again to an exemplary block diagram illustrated in FIG. 1 and an exemplary chart illustrated in FIG. 8, a method can be used to reduce the price of a Dive based upon a last known trajectory. That is, the price of a Dive can be configured to decrease dynamically even viewer's 108 connection to the Internet, module 106 and/or operations platform 120 is lost.

In order to reduce the price of a Dive based upon a last known trajectory, PDA 104, module 106 and/or server 114 can be configured to compute the current “state” of a Dive. The state of a Dive can comprise at least one of the price, highest current bid on a Dive, time left of Dive, and/or status of a Dive (i.e., whether the Dive has started, is about to start, and/or is about to finish). In computing the current “state” of a Dive, various Dive data can be taken into account, such Dive data including but not limited to a start time, end time, start price, end price, number of viewers, types of viewers, number of bids, amount of bids, and/or the like. For example, for a linear Dive, if a Dive starts at 1:00 (startTime) at $10 (startprice) and is set to end at 2:00 (endTime) at $0 (endPrice), PDA 104 can be configured to compute a “currentPrice” for a current intermediate time, such as 1:30 (the currentTime). That is, the current price can be calculated as follows: currentPrice=startPrice+(endprice−startPrice)*(currentTime−endTime)/(startTime−endTime).

Because the currentPrice calculation may become complex in non-linear Dives if there are multiple bids, viewers and/or the like requesting a current price, PDA 104, module 106 and/or server 114 may be configured to have a two or more tiered system for current price calculations. For example, in one exemplary embodiment, PDA 104, module 106 and/or server 114 is configured to have a three tiered system. A first tier, Tier1, is composed of static Dive data that is independent from any Dive lifecycle event. For example, in FIG. 8, Tier1 data 805 is constant over time and price. Tier1 Dive is not time dependent and comprises the set start time, set end time, start price, end price, listing description and/or static information of the like. A second tier, Tier2, is composed of data that is lifecycle event dependent yet time independent. For example, lifecycle event dependent data can include, but is not limited to data regarding the highest bidder, data regarding the highest quality bidder, data regarding the number of bidders, and/or the like. With respect to the exemplary chart depicted in FIG. 8, Tier2 data 810 changes in relation to discreet events. The third tier of data, Tier3, is composed of all time dependent data, including but not limited to the current price, time left before a Dive ends and/or the like. Accordingly, and again with respect to FIG. 8, Tier3 data takes the discreet Tier2 data and extrapolates it over time.

For example, in one exemplary embodiment, static Tier1 data is stored in database 102. PDA 104 and/or server 114 is configured to use the stored Tier1 data as well as dynamic Tier2 data received from module 106 to facilitate calculating an effective Dive state. That is, PDA 104 and/or server 114 uses the baseline Tier1 data to constantly recalculate a price based upon viewer information. This dynamically changing Tier1 data is considered Tier2 data. PDA 104 and/or server 114 is further configured to communicate the Tier2 data and/or calculations to module 106. Module 106 can then use the Tier2 information, as well as Tier3 time information to facilitate fast computation of a real-time state of a Dive. For example, PDA 104 and/or server 114 can use Tier2 data to calculate a Dive Velocity based upon the number of viewers of a Dive. PDA 104 and/or server 114 can communicate this information to module 106, wherein module 106 can use the information to determine the price of the Dive at a specific time. PDA 104 and/or server 116 can then use these Tier2 and Tier3 calculations to compute the actual time left until the Dive ends.

For the sake of brevity, conventional data networking, application development and other functional aspects of the systems (and components of the individual operating components of the systems) can not be described in detail herein. Furthermore, the connecting lines shown in the various figures contained herein are intended to represent exemplary functional relationships and/or physical couplings between the various elements. It should be noted that many alternative and/or additional functional relationships and/or physical connections can be present in a practical system.

The present invention has been described herein in terms of functional block components, block diagrams, flow charts, optional selections and various processing steps. It should be appreciated that such functional blocks can be realized by any number of hardware and/or software components configured to perform the specified functions. For example, the present invention can employ various integrated circuit components (e.g., memory elements, processing elements, logic elements, look-up tables, and the like), which can carry out a variety of functions under the control of one and/or more microprocessors and/or other control devices. Similarly, the software elements of the present invention can be implemented with any programming and/or scripting language such as C, C++, Java, COBOL, assembler, PERL, Visual Basic, SQL Stored Procedures, extensible markup language (XML), hypertext markup language (HTML), with the various algorithms being implemented with any combination of data structures, objects, processes, routines and/or other programming elements. Further, it should be noted that the present invention can employ any number of conventional techniques for data transmission, signaling, data processing, network control, and the like.

Moreover, it will be understood that each functional block of the block diagrams and the flowchart illustrations, and combinations of functional blocks in the block diagrams and flowchart illustrations, respectively, can be implemented by computer program instructions. These computer program instructions can be loaded onto a general purpose computer, special purpose computer, and/or other programmable data processing apparatus to produce a machine, such that the instructions that execute on the computer and/or other programmable data processing apparatus create means for implementing the functions specified in the flowchart block and/or blocks.

These computer program instructions can also be stored in a computer-readable memory that can direct a computer and/or other programmable data processing apparatus to function in a particular manner, such that the instructions stored in the computer-readable memory produce an article of manufacture including instruction means which implement the function specified in the flowchart block and/or blocks. The computer program instructions can also be loaded onto a computer and/or other programmable data processing apparatus to cause a series of operational steps to be performed on the computer and/or other programmable apparatus to produce a computer-implemented process such that the instructions which execute on the computer and/or other programmable apparatus provide steps for implementing the functions specified in the flowchart block and/or blocks.

Accordingly, functional blocks of the block diagrams and flowchart illustrations support combinations of means for performing the specified functions, combinations of steps for performing the specified functions, and program instruction means for performing the specified functions.

As will be appreciated by one of ordinary skill in the art, the present invention can be embodied as a method, a data processing system, a device for data processing, and/or a computer program product. Accordingly, the present invention can take the form of an entirely software embodiment, an entirely hardware embodiment, and/or an embodiment combining aspects of both software and hardware. Furthermore, the present invention can take the form of a computer program product on a computer-readable storage medium having computer-readable program code means embodied in the storage medium. Any suitable computer-readable storage medium can be utilized, including hard disks, CD-ROM, optical storage devices, magnetic storage devices, and/or the like.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “comprises,” “comprising,” “include,” “have,” and/or any other variation thereof, are intended to cover a non-exclusive inclusion, such that a process, method, article, and/or apparatus that comprises a list of elements does not include only those elements but may include other elements not expressly listed and/or inherent to such process, method, article, and/or apparatus. Further, no element described herein is required for the practice of the invention unless expressly described as “essential” and/or “critical.”

What we claim:

1. A distributed commerce system comprising:
a commerce site providing product information related to a product offered for sale at a first sale price and an advertisement;
a central processor in communication with the commerce price, the central processor configured for calculating a rate of advertising subsidy based on a number of visitors to the commerce site;
a module for communicating the advertisement and product information between the central processor and the commerce site;
a counter, within the module, for counting the number of visitors to the commerce site, wherein the module communicates the number of visitors to the central processor;
wherein the central processor calculates a second sale price based upon the number of visitors and the rate of advertising subsidy, and wherein the central processor communicates the second sale price to the commerce site through the module.

2. The system of claim 1, wherein the module is configured as a stand-alone device.

3. The system of claim 2, wherein the commerce site comprises a retail store.

4. The system of claim 1, wherein the commerce site comprises both a retail store and a web page accessible through an Internet.

5. The system of claim 1, wherein the central processor is further configured to calculate a rate of reduction from the first sale price to the second sale price.

6. The system of claim 5, wherein the rate of reduction of the sale price is based upon a minimum sale price, a maximum sale price and the number of visitors to the commerce site.

7. A distributed commerce system comprising:
a central processor containing sale information related to a sale of a product and viewer information comprising weighting information relating to at least two types of viewers;
a module for communicating the viewer and sale information to a commerce site, the sale information comprising a sale price;
a detection mechanism, within the module, for determining which type of viewer is viewing the commerce site, wherein the module communicates the type of viewer to the central processor;
wherein the central processor calculates a sale price based upon the type of viewer, and wherein the central processor communicates the sale price to the module at the commerce site.

8. The system of claim 7, wherein the weighting information relates to a viewer's market profile.

9. The system of claim 7, wherein the at least two types of viewers are a prime viewer and a sub viewer.

10. The system of claim 9, wherein the weighting information is higher for a prime viewer than it is for a sub viewer.

11. The system of claim 9, wherein the central processor calculates a lower sale price for a prime viewer than for a sub user.

12. The system of claim 7, further comprising an advertising application, wherein the advertising application is assessed a fee based upon the type of viewer viewing the commerce site.

13. The system of claim 12, wherein the advertising application is assessed a higher fee for a prime viewer than for a sub viewer.

14. The system of claim 7, further comprising an advertising application, wherein the advertising application is assessed a fee based on a number of viewers viewing the commerce site.

15. A dynamic pricing tag comprising:
a pricing tag coupled to a product, the pricing tag displaying a first price of the product;
a first viewer module configured for facilitating interaction between a first viewer and the pricing tag;
a second viewer module configured for facilitating interaction between a second viewer and the pricing tag;
a central processor in communication with the pricing tag and the first and second viewer modules, wherein the central processor calculates a rate of subsidy based on the first and second viewers viewing the product and wherein the central processor calculates a second price of the product based on the rate of subsidy; and
wherein the central processor communicates the second sale price to the pricing tag.

16. The pricing system of claim 15, wherein the viewer module is configured as a stand-alone device.

17. The pricing tag of claim 15, wherein the rate of subsidy is based upon a minimum sale price, a maximum sale price and a number of viewers viewing the product.

18. The pricing tag of claim 15, wherein the central processor is in radio frequency communication with the pricing tag.

19. The pricing tag of claim 15, wherein the pricing tag comprises a digital display.

20. The pricing tag of claim 15, wherein the rate of subsidy is based upon a weight of a viewer viewing the product.

21. The pricing tag of claim 15, wherein the pricing tag is further configured to display an advertisement.

22. The pricing tag of claim 21, wherein an advertiser subsidizes an amount of a difference between the first price and the second price based upon at least one of a number of viewers viewing the product and a weight of a viewer viewing the product.

23. A method for dynamic pricing, the method comprising:
storing, in a database, information relating to a product, including a first product price;
establishing at a central processor, a minimum price velocity percentage and an upper price velocity percentage, wherein the minimum and upper price velocity percentages are each based on the first product price;
receiving viewer information, at a module in communication with a commerce site;
communicating the viewer information to the central processor;
calculating a second product price based upon the product information, the minimum price velocity percentage, the upper price velocity percentage and the viewer information; and
transmitting the second product price to a commerce site using the module.

24. The method of claim 23, further comprising a step of assigning a weight to a viewer based on the viewer information.

25. The method of claim 24, wherein the calculating step further comprises calculating the second product price based upon the weight of the viewer.

26. The method of claim 23, further comprising a step of receiving an advertising subsidy based upon the viewer information.

27. The method of claim 26, wherein the calculating step further comprises calculating the second product price based upon the advertising subsidy.

28. The method of claim 23, wherein the step of receiving viewer information, at a module in communication with a commerce site, comprises receiving viewer information at a stand-alone device.

29. The method of claim 23, wherein the step of receiving viewer information, at a module in communication with a commerce site, comprises receiving viewer information, at a module in communication with a retail store.

30. The method of claim 23, wherein the step of receiving viewer information, at a module in communication with a commerce site, comprises receiving viewer information, at a module in communication with a website accessible through an Internet.

31. A method for real-time processing of data comprising:
retrieving a static data from a database;
calculating an effective price, at a server, wherein the effective price is based upon the retrieved static data and a discreet event data;
communicating the effective price to a module;
calculating a real-time price at the module, wherein the real-time price is based upon the effective price and a real-time event data.

32. The method of claim 31, wherein the step of retrieving a static data comprises retrieving at least one of a set start time, set end time, start price, end price, and product listing description.

33. The method of claim 31, wherein the step of calculating an effective price is based upon static data comprising at least one of a set start time, set end time, start price, end price, and product listing and a discreet event data comprising at least one of data regarding a highest bidder, data regarding a highest weighted bidder, and data regarding a number of bidders.

34. The method of claim 31, wherein the step of calculating a real-time price is based upon a discreet event data comprising at least one of data regarding a highest bidder, data regarding a highest weighted bidder, and a real-time event data comprising at least one of a current price, and a time left before a Dive.
